(19) United States
(12) Patent Application Publication
(10) Pub. No.: US 2022/0203531 A1
(43) Pub. Date: Jun. 30, 2022

(54) ROBOT, TRANSMISSION METHOD, AND TRANSMISSION ESTIMATION METHOD

(71) Applicant: SONY GROUP CORPORATION, TOKYO (JP)

(72) Inventor: YUDAI YUGUCHI, TOKYO (JP)

(21) Appl. No.: 17/602,470

(22) PCT Filed: Apr. 10, 2020
(86) PCT No.: PCT/JP2020/016220

§ 371 Date: Oct. 8, 2021

(30) Foreign Application Priority Data
Apr. 17, 2019 (JP) 2019-078548

(51) Int. Cl. B25J 9/16

(52) U.S. Cl. CPC B25J 9/1664; B25J 9/1674; B25J 9/1679; B25J 9/1653; B25J 9/1697

(57) ABSTRACT

A robot (100) includes a movable portion (100M) transformable into a plurality of different forms; a storage unit (31) that stores relationship information indicating a relationship between the form of the movable portion (100M) and transmission information; a specifying unit (322) that specifies a form of the movable portion (100M) used for transmitting the transmission information to a transmission target based on the relationship information; and an operation control unit (323) that performs control to transform the movable portion (100M) into the form specified by the specifying unit (322).

### FIELD

The present disclosure relates to a robot, a transmission method, and a transmission estimation method.

### BACKGROUND

Examples of robots include a robot having a movable portion. Patent Literature 1 discloses a robot control method and the like in which an interaction request toward a robot is detected, detection data indicating the detected interaction request is output including reliability of detection, and when the reliability is higher than a predetermined level, a movable portion is allowed to operate based on the detection data.

### CITATION LIST

### Patent Literature

Patent Literature 1: JP 2012-40655 A

### SUMMARY

### Technical Problem

In the above-described background art, in a case where a robot transmits information to another robot or a human by communication, voice recognition, and the like, an occurrence of, for example, communication abnormality, a situation having difficulty in recognizing voice, and the like sometimes makes it difficult for the robot to transmit information to the outside. For this reason, there is a need, in the conventional robot, to be able to transmit information to the outside even with an occurrence of a communication abnormality.

In view of this, the present disclosure provides a robot, a transmission method, and a transmission estimation method capable of transmitting information to a transmission target without being affected by communication abnormality.

### Solution to Problem

To solve the problems described above, a robot includes: a movable portion transformable into a plurality of different forms; a storage unit that stores relationship information indicating a relationship between the form and transmission information; a specifying unit that specifies the form used for transmitting the transmission information to a transmission target based on the relationship information; and a first control unit that performs control to transform the movable portion into the form specified by the specifying unit.

Moreover, a robot includes: a storage unit that stores relationship information indicating a relationship between transmission information and a form of a movable portion on a transmission side that transmits the transmission information; an imaging unit that images the movable portion on the transmission side; a recognition unit that recognizes the form of the movable portion on the transmission side based on imaging information obtained by imaging by the imaging unit; and an estimation unit that estimates the transmission information on the transmission side based on the relationship information and the form recognized by the recognition unit.

Moreover, a transmission method to be executed by a robot including a movable portion transformable into a plurality of different forms includes: storing relationship information indicating a relationship between the form and transmission information into a storage unit; specifying the form of transmitting the transmission information to a transmission target based on the relationship information; and transforming the movable portion into the specified form.

Moreover, a transmission estimation method to be executed by a computer including a storage unit that stores relationship information indicating a relationship between transmission information and a form of a movable portion on a transmission side that transmits the transmission information includes: imaging the movable portion on the transmission side by an imaging unit; recognizing the form of the movable portion on the transmission side based on imaging information obtained by imaging; and estimating the transmission information on the transmission side based on the relationship information and the form that has been recognized.

### BRIEF DESCRIPTION OF DRAWINGS

FIG. 1 is a diagram illustrating an example of a robot according to an embodiment.

FIG. 2 is a diagram illustrating a robot configuration example according to the embodiment.

FIG. 3 is a diagram illustrating an example of relationship information of the robot according to the embodiment.

FIG. 4 is a diagram illustrating an information transmission rule in a single form.

FIG. 5 is a diagram illustrating an information transmission rule in a continuous form.

FIG. 6 is a flowchart illustrating an example of a processing procedure to be executed by a robot on the transmission side according to the embodiment.

FIG. 7 is a flowchart illustrating an example of a processing procedure to be executed by the robot on the receiver side according to the embodiment.

FIG. 8 is a diagram illustrating an operation environment of the robot according to the embodiment.

FIG. 9 is a diagram illustrating an operation related to transmission between robots according to the embodiment.

FIG. 10 is a diagram illustrating operation of a robot according to Modification (1) of the embodiment.

FIG. 11 is a diagram illustrating operation of a robot according to Modification (2) of the embodiment.

FIG. 12 is a diagram illustrating operation of a robot according to Modification (3) of the embodiment.

FIG. 13 is a hardware configuration diagram illustrating an example of a computer that actualizes functions of an information processing device.

### DESCRIPTION OF EMBODIMENTS

Embodiments of the present disclosure will be described below in detail with reference to the drawings. In each of the following embodiments, the same parts are denoted by the same reference symbols, and a repetitive description thereof will be omitted.

[Overview of Present Disclosure]

The robot uses a wide variety of sensors to grasp the robot's own state and surrounding environment status and then executes appropriate processes for a given command. At the time of operation of the robot, the operator or the developer needs to constantly monitor whether the robot is in the normal state, and is required to repair the robot promptly when an abnormality is found. In addition, exchanging information such as a command and the robot's own state between a human and the robot or between a plurality of robots sometimes uses a network environment. With use of a network, the robot not only sends commands to each other but also sends logs including information of various sensors, thereby enabling detailed analysis at an occurrence of a failure.

For example, utilization of a robot includes a case where a plurality of robots shares their task information, environment information, states of the robots, and the like via a network and executes a task in cooperation. In such a case, when even one of the plurality of robots has a difficulty in communication, the smooth execution of the task would be affected. To handle this, in a case where it is necessary to continue a task even with an occurrence of communication difficulty between a plurality of robots, it is desired to transmit a command and the like between the robots and to share information regarding the robots and the environment by using a method other than a network.

In addition, an example of a method that allows a human to grasp the state of the robot other than the use of a network is a method of continuously displaying information on a display directly attached to the robot. This makes it possible to obtain, from the robot on the spot, the equivalent amount of information as in a case where information is transmitted to a human-managed system or the like via a network. On the other hand, it is difficult for a human to send a command to a robot or for a certain robot to send a command to another robot.

Another method for the human to grasp the state of the robot is a method of making discrimination by colors indicated by the robot. For example, with indication of colors, such as green: normal, yellow: abnormal (no problem in task execution), and red: dangerous (possible influence on task execution) defined in advance for a lamp attached to the robot, it would be possible to intuitively grasp from the outside whether the robot is in a normal state. In the case of a robot, however, it is difficult to externally grasp what type of trouble has occurred in which part when an abnormality is detected. For example, although increasing the types of colors could increase the amount of information, there remains a problem that it is difficult to intuitively understand numerical values and faulty portions only by colors. In addition, even though commands can be transmitted by colors between a human and a robot or between robots, there is a need, at that time, to extract colors related to the commands from among various types of color information existing in the surrounding environment.

Another method for grasping the state of the robot is a method using sound. Type of sound can be a beep sound and a melody, as well as a specific language, which can be used to transmit a large amount of information. However, the transmission method using sound has a possibility that the sound is canceled by the sound around the robot or even the emitted sound itself becomes noise.

The present disclosure aims to implement a robot, a robot transmission method, and the like capable of transmitting information to a transmission target without being affected by communication abnormality, surrounding noise, and the like. The transmission target includes, for example, a robot, a human, and the like. For example, in a case where the robot has a failure in communication with another robot or a human or has a difficulty in use of the voice recognition function, the robot can share information or transmit a command by using a predetermined indication of a form of a movable portion.

Although the present embodiment below will be described on the premise that the robot has a communication means via wireless or wired channels, etc. a voice recognition function, and the like, the present disclosure is not limited thereto. For example, the robot may have a configuration not including a communication means or a voice recognition function. In addition, the description will be given on the premise that the robot has a difficulty in normally using a voice recognition function because of surrounding noise, etc., even with the voice recognition function, or has a difficulty in using the voice recognition function due to a reason such as necessity of quietly executing the task, and the like.

### EMBODIMENTS

### Overview of Robot According to Embodiment

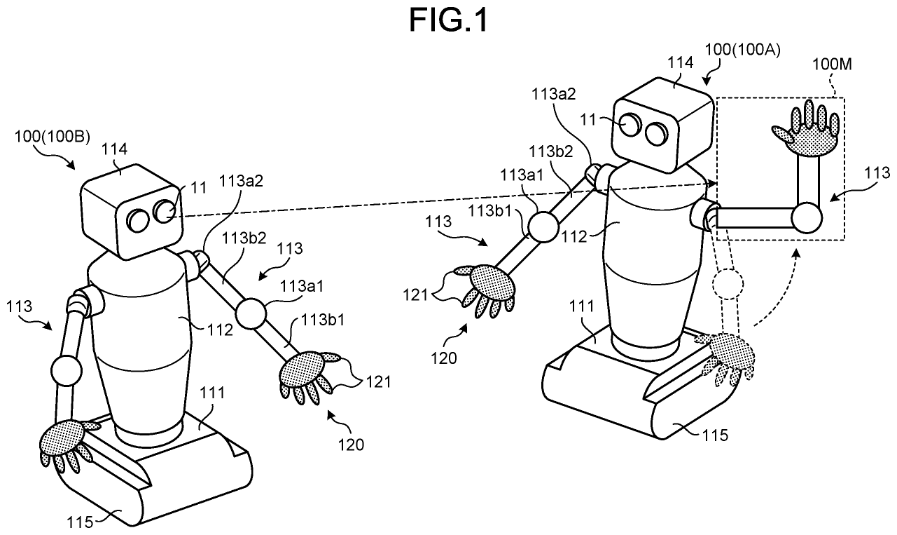

FIG. 1 is a diagram illustrating an example of a robot according to an embodiment. As illustrated in FIG. 1, a robot 100 is, for example, a dual-arm humanoid robot. The robot 100 includes, for example, an autonomous mobile robot that moves in a factory, a facility, a house, and the like. The robot 100 performs work in cooperation with another robot 100, a human, and the like.

The robot 100 includes a main body 110. The main body 110 includes a base unit 111, a body unit 112, an arm 113, and a head 114. The base unit 111 is a foundation and includes a moving mechanism 115 that moves the robot 100. The moving mechanism 115 is a means of moving the main body 110, and is formed with a wheel, a leg, and the like. The body unit 112 is movably supported on the base unit 111. The arm 113 extends from the body unit 112 and is movably provided. The head 114 is movably provided in an upper portion of the body unit 112.

The head 114 includes an imaging unit 11 that images the front of the main body 110. Hereinafter, in the main body 110, a surface on which the imaging unit 11 is provided is referred to as a front surface, a surface opposing the surface on which the imaging unit 11 is provided is referred to as a rear surface, and a surface sandwiched between the front surface and the rear surface and oriented in a direction other than a vertical direction is referred to as a side surface. An example of the imaging unit 11 is an optical camera or the like. The imaging unit 11 can be used to detect a transmission target to which the robot 100 transmits information. The transmission target includes, for example, another robot, a human, an electronic device having a recognition function, and the like.

The arm 113 is provided in plurality in the body unit 112. The number of arms 113 can be any number. In the example illustrated in FIG. 1, two arms 113 are provided symmetrically on two opposing side surfaces of the body unit 112. The arm 113 is, for example, a 7-degree-of-freedom arm. The arm 113 is provided with, on its distal end, a hand 120 capable of holding an object. The hand 120 is formed of a metal material, a resin material, or the like.

The arm 113 has a plurality of links pivotably joined by a joint. For example, the arm 113 is an articulated arm including a plurality of joints 113a1 and 113a2 and a plurality of links 113b1 and 113b2 joined by the joints 113a1. In the example illustrated in FIG. 1, the configuration of the arm 113 is simplified for the sake of simplicity. In practice, the shapes, the number and the arrangement of the joints 113a1 and 113a2 and the links 113b1 and 113b2, the directions of the rotation axes of the joints 113a1 and 113a2 and the like can be appropriately set so as to give the arm 113 a desired degree of freedom. For example, the arm 113 can be suitably configured to have six or more degrees of freedom. With this configuration, the robot 100 can freely operate the arm 113 within an operable range of the arm 113.

For example, actuators are provided in the joints 113a1 and 113a2. The joints 113a1 and 113a2 are rotatable around a predetermined rotation axis by the drive of the actuator. The drive of the actuator is controlled by a control unit of the robot 100, thereby controlling the rotation angle of each of the joints 113a1 and 113a2 and controlling the drive of the arm 113. With this configuration, the control of the operation and the posture (form) of the arm 113 can be implemented. At this time, the control unit of the robot 100 can control the drive of the arm 113 by various known control schemes such as force control or position control. In the present embodiment, the robot 100 further includes a control unit that controls the arm 113 (articulated arm). The control unit includes, for example, a processor such as a central processing unit (CPU), and operates following a predetermined program to control the drive of the arm 113 following a predetermined control scheme. The control unit provides a function of controlling the operation of the arm 113 according to the information to be transmitted to the transmission target.

The hand 120 has a plurality of fingers 121. Each of the plurality of fingers 121 is movable by an actuator provided in an interphalangeal joint. Each of the plurality of fingers 121 is configured to be extendable or bendable, for example. The hand 120 can widen or narrow a space between adjacent fingers 121 among the plurality of fingers 121.

In the present embodiment, the arm 113 can express a plurality of different types of postures by the pivoting of the joints 113a1 and 113a2. The hand 120 can express a plurality of different types of postures by combining operations of bending, stretching, widening the interval, and narrowing the interval of the finger 121. The robot 100 implements transmission of information using the posture based on the posture of the arm 113, the posture of the hand 120, and the posture obtained by combining the arm 113 and the hand 120. Note that the robot 100 may be configured to transmit information using the entire posture of the main body 110 including the body unit 112, the arm 113, and the head 114.

Although the example illustrated in FIG. 1 is a case where the plurality of robots 100 causes the arm 113 and the hand 120 to function as a movable portion 100M, the present disclosure is not limited thereto. For example, the plurality of robots 100 may cause at least one of the body unit 112, the arm 113, the hand 120, or the head 114 to function as the movable portion 100M. Furthermore, the movable portion 100M may be the left and right arms 113 and the hand 120 or may be one of the left and right arms 113 and the hand 120 of the robot 100.

For example, the different number of arms of the robot 100 means the different number of forms that can be expressed by the movable portion 100M. With an increase of the number of arms of the robot 100 from 1, to 2, 3 or more, the number of forms that can be expressed by the movable portion 100M also increases. Therefore, in an environment in which the robots 100 having different numbers of arms are also used, it is desirable to have a matching between the movable portions 100M.

In the following description of distinguishing the two robots 100 from each other, the two robots 100 are referred to as a robot 100A and a robot 100B. In the scene illustrated in FIG. 1, the robot 100A is on a transmission side that transmits information, and the robot 100B is on a receiver side that receives information. By moving the left arm 113, the robot 100A indicates an intention to transmit information to the robot 100B in the neighborhood. Note that the robot 100A may simultaneously transmit information to a plurality of the robots 100B.

### Configuration of Robot According to Embodiment

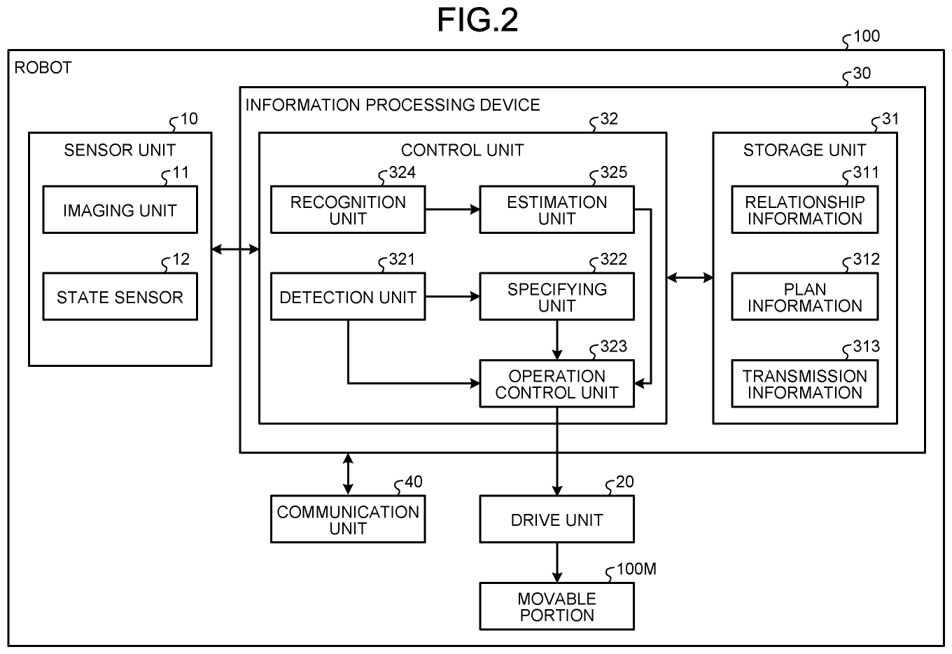

FIG. 2 is a diagram illustrating a configuration example of the robot 100 according to the embodiment. As illustrated in FIG. 2, the robot 100 includes a sensor unit 10, a drive unit 20, an information processing device 30, and a communication unit 40. The information processing device 30 is an example of the control unit of the robot 100 described above. The information processing device 30 is connected to the sensor unit 10, the drive unit 20, and the communication unit 40 so as to be able to exchange data and signals. For example, although the following is a case where the information processing device 30 is incorporated in the robot 100 as a unit that controls at least one of transmission and recognition of transmission information in the robot 100, the information processing device 30 may be provided outside the robot 100. Incidentally, the robot 100 may have a configuration not including the communication unit 40.

The sensor unit 10 includes various sensors and the like that detect information used for processes of the robot 100. The sensor unit 10 supplies the detected information to the information processing device 30 and the like. In the present embodiment, the sensor unit 10 includes the imaging unit 11 described above and a state sensor 12. The sensor unit 10 supplies sensor information indicating an image captured by the imaging unit 11 to the information processing device 30. The state sensor 12 includes, for example, a gyro sensor, an acceleration sensor, a surrounding information detection sensor, and the like. The surrounding information detection sensor detects an object around the robot 100, for example. Examples of the surrounding information detection sensor include an ultrasonic sensor, a radar, a light detection and ranging or laser imaging detection and ranging (LiDAR), and a sonar. The sensor unit 10 supplies sensor information indicating a detection result of the state sensor 12 to the information processing device 30.

For example, the sensor unit 10 may include various sensors for detecting the current location of the robot 100. Specifically, for example, the sensor unit 10 may include a global positioning system (GPS) receiver, a global navigation satellite system (GNSS) receiver that receives a GNSS signal from a GNSS satellite, and the like. For example, the sensor unit 10 may include a microphone that collects sound around the robot 100.

The drive unit 20 includes various devices related to a drive system of the robot 100. The drive unit 20 includes, for example, a driving force generator or the like for generating a driving force of a plurality of driving motors or the like. The driving motor causes the moving mechanism 115 of the robot 100 to operate, for example. The moving mechanism 115 includes, for example, functions corresponding to a moving form of the robot 100 such as wheels and legs. The drive unit 20 rotates the driving motor based on control information including a command or the like from the information processing device 30, for example, to achieve autonomous movement of the robot 100.

The drive unit 20 drives each drivable portion of the robot 100. The drive unit 20 includes an actuator that causes the movable portion 100M to operate. The drive unit 20 is electrically connected to the information processing device 30 and is controlled by the information processing device 30. The drive unit 20 drives the actuator to achieve transformation into the form of the movable portion 100M of the robot 100.

The communication unit 40 perform communication between the robot 100 and various external electronic devices, an information processing server, a base station, and the like. The communication unit 40 outputs data received from an information processing server or the like to the information processing device 30, and transmits data from the information processing device 30 to the information processing server or the like. Note that the communication protocol supported by the communication unit 40 is not particularly limited, and the communication unit 40 can support a plurality of types of communication protocols.

The information processing device 30 controls an operation in the robot 100 related to information transmission. The information processing device 30 is a dedicated or general-purpose computer, for example. The information processing device 30 has a function of controlling a moving operation, a posture, and the like of the robot 100.

The information processing device 30 controls the drive unit 20 to move the robot 100 along a target path based on an operation command (target position) of the robot 100. The operation command includes, for example, instruction information for moving the robot 100 along the target path, instruction information for maintaining the posture of the robot 100, and the like. For example, the information processing device 30 has a function of changing and re-planning an action plan in a case where the robot 100 cannot reach the destination due to an obstacle or the like.

The information processing device 30 includes a storage unit 31 and a control unit 32. The information processing device 30 may include at least one of the sensor unit 10 or the communication unit 40 in the configuration.

The storage unit 31 stores various data and programs. Examples of the storage unit 31 include random access memory (RAM), a semiconductor memory element such as a flash drive, a hard disk, an optical disk, or the like. The storage unit 31 stores, for example, various types of information such as relationship information 311, plan information 312, and transmission information 313. The relationship information 311 includes information indicating a relationship between the form of the movable portion 100M and the transmission information 313, for example. An example of the relationship information 311 will be described below. The plan information 312 includes information indicating an action plan of the robot 100, for example. The action plan includes, for example, information regarding an autonomous movement path of the robot 100, a position at which the robot 100 executes a task, and the like.

The transmission information 313 includes, for example, elements such as a transmission source, a transmission destination (transmission target), a position (location), a faulty portion, an importance level, and a type. The transmission source includes information capable of identifying the transmission side that transmits the transmission information 313, for example. The transmission destination includes information capable of identifying the receiver side that receives the transmission information 313, for example. The transmission destination includes, for example, information indicating a unique robot 100, all the robots 100, a human, the robot 100 and a human, and the like. The position includes, for example, information indicating a position such as an obstacle and occurrence of an accident. The faulty portion includes information indicating a faulty portion of the robot 100. The importance level includes information indicating the importance level of the transmission information 313. The type includes information indicating a type such as a report, a request, or a command set in the transmission information 313, for example.

The control unit 32 includes a detection unit 321, a specifying unit 322, an operation control unit 323, a recognition unit 324, and an estimation unit 325. Individual functional units including the detection unit 321, the specifying unit 322, the operation control unit 323, the recognition unit 324, and the estimation unit 325 are implemented by execution of a program stored in the information processing device 30 by a central processing unit (CPU), a micro control unit (MPU), or the like using the RAM or the like as a work area. In addition, each of the processing units may be implemented by an integrated circuit such as an application specific integrated circuit (ASIC) or a field-programmable gate array (FPGA).

The detection unit 321 detects an event of transmission of transmission information to the transmission target. The event of transmission includes an event of detecting a transmission target in a state where transmission information is occurring, for example. The event of transmission may include, for example, an event that an abnormality has occurred in the robot 100, that the transmission target is in a state ready to receive transmission, that transmission of information has been requested from another robot 100, that transmission information has been received from another robot 100, and the like. For example, the detection unit 321 detects a case where another robot 100, a human, an obstacle, or the like is included in the image captured by the imaging unit 11 of the sensor unit 10 as an event of transmission. For example, the detection unit 321 detects, as an event of transmission, a case where an abnormal signal from a sensor or the like provided in the robot 100 is detected. The detection unit 321 detects, as an event of transmission, confirmation that transmission information can be received. The detection unit 321 detects environment information of the robot 100 and supplies the environment information to the operation control unit 323.

The specifying unit 322 specifies a form of the movable portion 100M that transmits the transmission information to the transmission target based on the relationship information 311. For example, the specifying unit 322 acquires the transmission information from the storage unit 31 or the like. For example, in a case where there is one piece of transmission information, the specifying unit 322 specifies one form corresponding to the transmission information. For example, in a case where there is a plurality of pieces of transmission information, the specifying unit 322 specifies a plurality of forms corresponding to each of the plurality of pieces of transmission information, and arranges the plurality of forms in order of the plurality of pieces of transmission information. The specifying unit 322 supplies the specified form of the movable portion 100M to the operation control unit 323.

The operation control unit 323 performs control to transform the movable portion 100M into the form specified by the specifying unit 322. For example, the operation control unit 323 plans an operation for transforming the movable portion 100M into the form specified by the specifying unit 322, and controls the drive unit 20 based on an operation command based on the plan. The operation command includes, for example, instruction information for causing the movable portion 100M to operate in the target form, instruction information for maintaining the form of the movable portion 100M, and the like. As a result, the movable portion 100M of the robot 100 is transformed into a form corresponding to the transmission information.

The operation control unit 323 performs control to transform the movable portion 100M according to a plurality of forms specified by the specifying unit 322. For example, the operation control unit 323 plans an operation for transforming the movable portion 100M in the order of a plurality of forms, and controls the drive unit 20 on the basis of the operation command based on the plan. When the detection unit 321 has detected an event, the operation control unit 323 performs control to transform the movable portion 100M into the form specified by the specifying unit 322.

The operation control unit 323 has a function of controlling the drive unit 20 to move along the target path based on an operation command (target position) of the robot 100. The operation command includes, for example, instruction information for moving the robot 100 along the target path, instruction information for maintaining the posture of the robot 100, and the like. For example, the operation control unit 323 has a function of changing the target path along which the robot 100 moves based on the environment information detected by the detection unit 321.

The recognition unit 324 recognizes the form of the movable portion 100M of the transmission target based on imaging information regarding imagine performed by the imaging unit 11. For example, in a case where the transmission target is the robot 100, the recognition unit 324 recognizes the movable portion 100M of the arm 113 and the hand 120 in the robot 100. For example, in a case where the transmission target is a human, the recognition unit 324 recognizes a human arm and hand corresponding to the movable portion 100M of the robot 100, as the movable portion 100M. The recognition unit 324 supplies the recognition result to the estimation unit 325.

The estimation unit 325 estimates transmission information on the transmission side based on the relationship information 311 and the form of the movable portion 100M recognized by the recognition unit 324. For example, the estimation unit 325 extracts information associated with a form matching or similar to the form of the movable portion 100M from the relationship information 311, and estimates the extracted information as the transmission information 313. The estimation unit 325 supplies the estimated transmission information 313 to the operation control unit 323.

The operation control unit 323 has a function of executing processes based on the transmission information 313 estimated by the estimation unit 325. For example, in a case where the transmission information 313 includes a position element, the operation control unit 323 executes a process for avoiding the position. For example, when the transmission information 313 includes the element of a faulty portion, the operation control unit 323 executes a process for reporting the faulty portion of the robot 100. For example, in a case where the transmission information 313 includes an element of type, the operation control unit 323 executes a process for executing a report, a request, a command, or the like indicated by the type.

In the information processing device 30 according to the present embodiment, the detection unit 321, the specifying unit 322, and the operation control unit 323 cooperate with each other to implement a function on the transmission side that transmits the transmission information 313 to the transmission target. Furthermore, in the information processing device 30, the recognition unit 324, the estimation unit 325, and the operation control unit 323 cooperate with each other to implement a function on the receiver side that receives the transmission information 313. In the present embodiment, the operation control unit 323 is an example of a first control unit and a second control unit. Incidentally, the information processing device 30 may include an operation control unit 323 corresponding to each of the first control unit and the second control unit, for example.

The functional configuration example regarding the robot 100 according to the present embodiment has been described as above. The above configuration described with reference to FIG. 2 is merely an example, and the functional configuration of the robot 100 according to the present embodiment is not limited to such an example. The functional configuration of the robot 100 according to the present embodiment can be flexibly modified in accordance with specifications and applications.

[Relationship Information of Robot According to Embodiment]

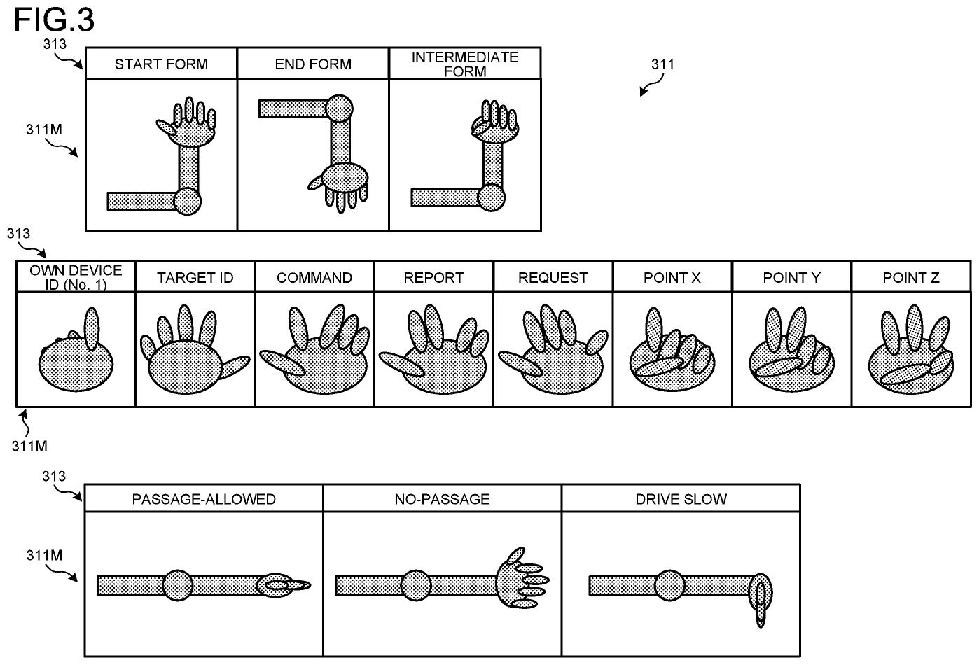

Next, an example of a form of the movable portion 100M will be described based on the relationship information 311 of the robot 100 according to the embodiment. FIG. 3 is a diagram illustrating an example of the relationship information 311 of the robot 100 according to the embodiment.

As illustrated in FIG. 3, the relationship information 311 is information that associates the transmission information 313 with a form 311M of the movable portion 100M. Although the example illustrated in FIG. 3 describes an exemplary case where the relationship information 311 links the transmission information 313 with the form 311M on a one-to-one basis, the present disclosure is not limited thereto. For example, the relationship information 311 may associate a plurality of pieces of transmission information 313 with one form 311M. Information indicating the form of the movable portion 100M is set as the form 311M of the relationship information 311. In the form 311M, for example, an image, a code, a text, and the like capable of identifying the form of the movable portion 100M are set. As the transmission information 313, for example, a word, a character string, a code, and the like to be transmitted are set.

In the example illustrated in FIG. 3, the transmission information 313 of the relationship information 311 includes a start form, an end form, an intermediate form, an own device ID, a target ID, a command, a report, a request, a point X, a point Y, a point Z, passage-allowed, no-passage, drive slow, and the like. The start form is a form indicating the start of the transmission information 313. The end form is a form indicating the end of the transmission information 313. The intermediate form is a form indicating continuation of the transmission information 313. In other words, the intermediate form is a form indicating joining of the preceding and following pieces of transmission information 313.

For example, in a case where the transmission information 313 indicates the start form, a form in which the bent arm 113 is directed upward with a left hand open is set as the form 311M. For example, in a case where the transmission information 313 indicates the end form, a form in which an arm bent in an L shape is directed downward with the left hand open is set as the form 311M. For example, in a case where the transmission information 313 indicates the intermediate form, a form in which an arm bent in an L shape is directed upward with the left hand gripped is set as the form 311M. For example, in a case where the transmission information 313 indicates the own device ID (No. 1), a form in which the index finger is raised with the back of the hand facing the transmission target is set as the form 311M. For example, in a case where the transmission information 313 is a command, a form in which the space between the index finger and the middle finger is widened with the palm with the stretched finger facing the transmission target. Although the present embodiment uses a case where the form 311M of the movable portion 100M is the form combining the shapes and orientations of the arm 113 and the hand 120, other forms may also be used.

For example, the robot 100 may include, in the relationship information 311, a form of pointing to the location of the occurring failure by the movable portion 100M. For example, when a failure is occurring in the moving mechanism 115, the robot 100 transforms the form of the movable portion 100M such that the hand 120 points to the moving mechanism 115. With this configuration, for example, the robot 100 can estimate the location of the failure from the outside before executing the log analysis of the inside of the device body.

Although the present embodiment is a case where the transmission side of the relationship information 311 on the robot 100 is the robot 100 and the receiver side is the robot 100 and a human, the present disclosure is not limited thereto. For example, the relationship information 311 may be configured differently depending on a target on the receiver side. For example, the relationship information 311 can have different configurations depending on the type, range, and the like of the transmission target. Note that the range of the transmission target means a range such as one transmission target, a plurality of transmission targets, or all of the transmission targets, for example. Furthermore, in a case where transmission is performed between the robot 100 and a human, the form indicated by the relationship information 311 is desirably a form that can be used for transmission by a human.

### Transmission Rules for Robot According to Embodiment

The robot 100 according to the embodiment can perform transmission using transmission rules (protocols) in a single form and a continuous form.

<Transmission Rule in Single Form>

The transmission rule of a single form can be used when information is transmitted by one type of form of the movable portion 100M that does not change with time, and the like. For example, the robot 100 built to resemble a human uses a form of individual joints of parts such as a shoulder, an arm, and a finger or a combination of the joints. Furthermore, in a case where the robot 100 has a plurality of the same parts, a single form may be set by combining the parts. By combining various parts such as a plurality of arms, fingers, and feet, the robot 100 can increase the amount of information transmitted at one time.

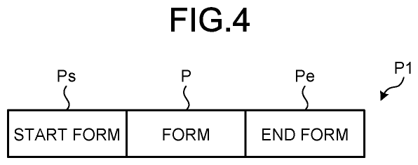

FIG. 4 is a diagram illustrating a transmission rule of information in a single form. As illustrated in FIG. 4, a transmission rule P1 includes a procedure Ps, a procedure P, and a procedure Pe. The procedure Ps is a procedure of transforming the movable portion 100M into a start form. The procedure P is a procedure of transforming the movable portion 100M into the form of the transmission information 313. The procedure Pe is a procedure of transforming the movable portion 100M into an end form. In the present embodiment, a case where the transmission rule P1 includes the procedure Ps and the procedure Pe will be described, but the present disclosure is not limited thereto. For example, the transmission rule P1 may be a procedure in which the procedure Ps and the procedure Pe are not added to the procedure P or only the procedure Ps is added to the procedure P.

By adding the procedure Ps and the procedure Pe to the procedure P, the transmission rule P1 distinguishes between the form 311M of the procedure P and a certain posture of the robot 100 during task operation. As a result, the transmission rule P1 enables transmission of the form of the movable portion 100M after transmitting the start form to the transmission target, making it possible to avoid erroneous recognition of the transmission target.

When using the transmission rule of a single form, the robot 100 selects elements necessary for transmission from among the transmission information 313 of the relationship information 311, and specifies one form 311M expressed by combining the forms 311M of the selected elements. By transforming the movable portion 100M into one specified form 311M, the robot 100 transmits a plurality of pieces of transmission information 313 to the transmission target all at once.

<Transmission Rule in Continuous Form>

The transmission rule in the continuous form can be used in a case where the transmission information 313 more detailed than the single form is transmitted by executing the single form a plurality of times. In the transmission rule of the continuous form, the number of forms of the movable portion 100M used to transmit the transmission information 313 is reduced as compared with the single form.

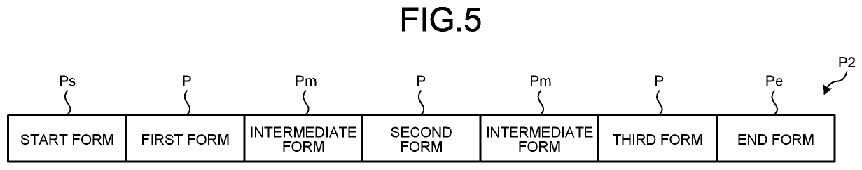

FIG. 5 is a diagram illustrating a transmission rule of information in a continuous form. As illustrated in FIG. 5, a transmission rule P2 includes a procedure Ps, a plurality of procedures P, a procedure Pe, and a plurality of procedures Pm. The procedure Pm is a procedure for transformation into an intermediate form. The transmission rule P2 is a procedure in which the procedure Pm is provided between continuous procedures P. Similarly to the transmission rule P1, the transmission rule P2 may be a procedure in which the procedure Ps and the procedure Pe are not added to the head and the tail of the plurality of procedures P, or only the procedure Ps is added to the procedure P at the head.

In the example illustrated in FIG. 5, the transmission rule P2 represents a set of procedures including a procedure Ps, a first procedure P, a procedure Pm, a second procedure P, a procedure Pm, a third procedure P, and a procedure Pe. The transmission rule P2 indicates a procedure of transforming the movable portion 100M in the order of the start form, the first form, the intermediate form, the second form, the intermediate form, the third form, and the end form.

By continuously transforming the form of the movable portion 100M by the plurality of procedures P, the transmission rule P2 transmits the plurality of pieces of transmission information 313 as one piece of information. By incorporating the intermediate form of the procedure Pm between adjacent forms 311M, the transmission rule P2 can reset the transmission information 313 indicated by the forms 311M adjacent to each other. With the use of the procedure Pm, the transmission rule P2 can the allow the transmission target to distinguish the continuous forms 311M of the movable portion 100M.

When using the transmission rule in the continuous form, the robot 100 specifies a plurality of forms 311M associated with elements necessary for transmission from among the transmission information 313 of the relationship information 311. With an intermediate form being interposed between the plurality of specified forms 311M, the robot 100 sequentially transforms the movable portion 100M into the forms 311M, thereby transmitting the plurality of pieces of transmission information 313 to the transmission target. By using the transmission rule P2 in the continuous form, the robot 100 can transmit the transmission information 313 in more detail than by using the transmission rule P1 in the single form, and can simplify the form 311M of the movable portion 100M. With the simplified form 311M of the movable portion 100M, the robot 100 can suppress erroneous recognition of the transmission target.

For example, when there is a small number of forms 311M that can be formed by the movable portion 100M, the robot 100 can subdivide the transmission information 313 by using the continuous form. In other words, the robot 100 can associate different transmission information 313 with the same form 311M for each transmission order of the continuous form. With this configuration, the robot 100 can transmit detailed information with a small number of the form 311M of the movable portion 100M.

[Processing Procedure on Transmission Side of Robot According to Embodiment]

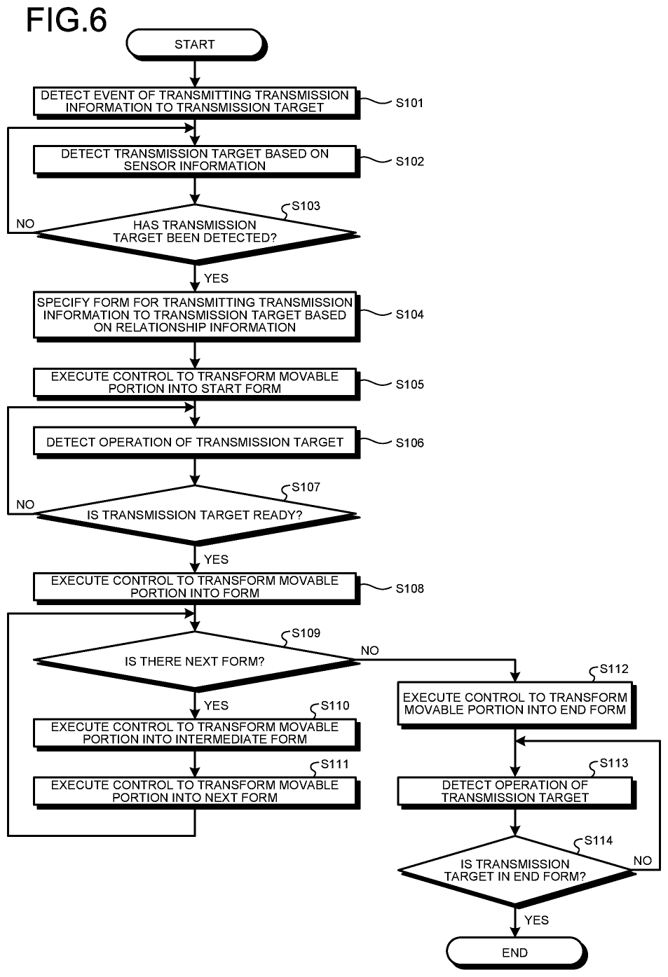

Next, a processing procedure on the transmission side of the robot 100 according to the embodiment will be described with reference to FIG. 6. FIG. 6 is a flowchart illustrating an example of a processing procedure to be executed by the robot 100A on the transmission side according to the embodiment. The processing procedure illustrated in FIG. 6 is actualized by execution of a program by the control unit 32 of the robot 100A.

As illustrated in FIG. 6, the robot 100A detects an event of transmission of the transmission information 313 to the transmission target (Step S101). For example, the robot 100A detects an event of transmission based on the detection result of the sensor unit 10. When having detected the event of transmission, the robot 100A proceeds to the process of Step S102.

The robot 100A detects a transmission target based on sensor information (Step S102). For example, the robot 100A requests the imaging unit 11 of the sensor unit 10 to capture an image, and detects a transmission target in the vicinity of the robot 100A based on the image captured by the imaging unit 11. The robot 100A determines whether the transmission target has been detected (Step S103). When having determined that the transmission target has not been detected (No in Step S103), the robot 100A returns to the process of Step S102 described above, and repeats the process of Step S102. In contrast, when having determined that the transmission target has been detected (Yes in Step S103), the robot 100A proceeds to the process of Step S104.

The robot 100A specifies a form 311M for transmitting the transmission information 313 to the transmission target based on the relationship information 311 (Step S104). For example, when transmitting “no-passage through point X” to the transmission target, the robot 100A specifies two forms 311M, namely, “point X” and “no-passage”. When having specified the form 311M, the robot 100A proceeds to the process of Step S105.

The robot 100A executes control to transform a movable portion 110M into a start form (Step S105). For example, the robot 100A performs a process of controlling the drive of the drive unit 20 to bring the movable portion 100M to the start form. After the movable portion 100M has been transformed into the start form, the robot 100A proceeds to the process of Step S106.

The robot 100A detects the operation of the transmission target (Step S106). For example, the robot 100A recognizes the form 311M of the movable portion 100M as the transmission target based on the image captured by the imaging unit 11. The robot 100A determines whether the transmission target is ready based on the detection result of Step S106 (Step S107). For example, when the movable portion 100M as the transmission target is in the start form, the robot 100A determines that the transmission target is ready. When having determined that the transmission target is not ready (No in Step S107), the robot 100A returns to process of Step S106 described above and waits for the transmission target to be ready. When having determined that the transmission target is ready (Yes in Step S107), the robot 100A proceeds to the process of Step S108.

The robot 100A executes control to transform the movable portion 100M into the form 311M (Step S108). For example, the robot 100A performs a process of controlling the drive of the drive unit 20 so that the movable portion 100M indicates the form 311M of the transmission information 313. For example, in a case where a plurality of forms 311M is specified, the robot 100A performs a process of controlling the drive of the drive unit 20 so that the movable portion 100M is transformed into the first form 311M. When the movable portion 100M has been transformed into the form 311M, the robot 100A proceeds to the process of Step S109.

The robot 100A determines whether there is the next form 311M based on the result specified in Step S104 (Step S109). When having determined that there is the next form 311M (Yes in Step S109), the robot 100A proceeds to the process of Step S110.

The robot 100A executes control to transform the movable portion 100M into an intermediate form (Step S110). For example, the robot 100A performs a process of controlling the drive of the drive unit 20 so as to bring the movable portion 100M to the intermediate form. When the movable portion 100M has been transformed into the intermediate form, the robot 100A proceeds to the process of Step S111.

The robot 100A executes control to transform the movable portion 100M into the next form 311M (Step S111). For example, the robot 100A performs a process of controlling the drive of the drive unit 20 so as to bring the movable portion 100M to the next form 311M of the transmission information 313. When the movable portion 100M has been transformed into the next form 311M, the robot 100A returns to the process of Step S109 described above, and continues the process of Step S109 and subsequent steps.

When having determined that there is no next form 311M (No in Step S109), this means the robot 100A has transmitted all the transmission information 313, and thus the robot 100A proceeds to the Step S112. The robot 100A executes control to transform the movable portion 100M into an end form (Step S112). For example, the robot 100A performs a process of controlling the drive of the drive unit 20 so as to bring the movable portion 100M to the end form. When the movable portion 100M has been transformed into the end form, the robot 100A proceeds to the process of Step S113.

The robot 100A detects an operation of the transmission target (Step S113). The robot 100A determines whether the transmission target is in the end form based on the detection result of Step S113 (Step S114). In the present embodiment, it is assumed that the transmission target transforms the movable portion 100M into the end form when having recognized the transmission information 313. When having determined that the transmission target is not in the end form (No in Step S114), the robot 100A returns to the process of Step S113 described above and waits for the transmission target to be in the end form. Note that, in a case where re-transmission of the transmission information 313 is requested from the transmission target, the robot 100A may execute the processes of Step S105 and subsequent steps. When having determined that the transmission target is the end form (Yes in Step S114), the robot 100A ends the processing procedure illustrated in FIG. 6 since the transmission information 313 has been recognized as the transmission target.

In the example of the processing procedure illustrated in FIG. 6, the robot 100A executes the processes of Steps S102 to S103, Steps S106 to S107, and Steps S113 to S114, whereby the control unit 32 functions as the detection unit 321. The robot 100A executes the process of Step S104, whereby the control unit 32 functions as the specifying unit 322. The robot 100A executes the processes of Step S105 and Steps S108 to S112, whereby the control unit 32 functions as the operation control unit 323.

[Processing Procedure on Receiver Side of Robot According to Embodiment]

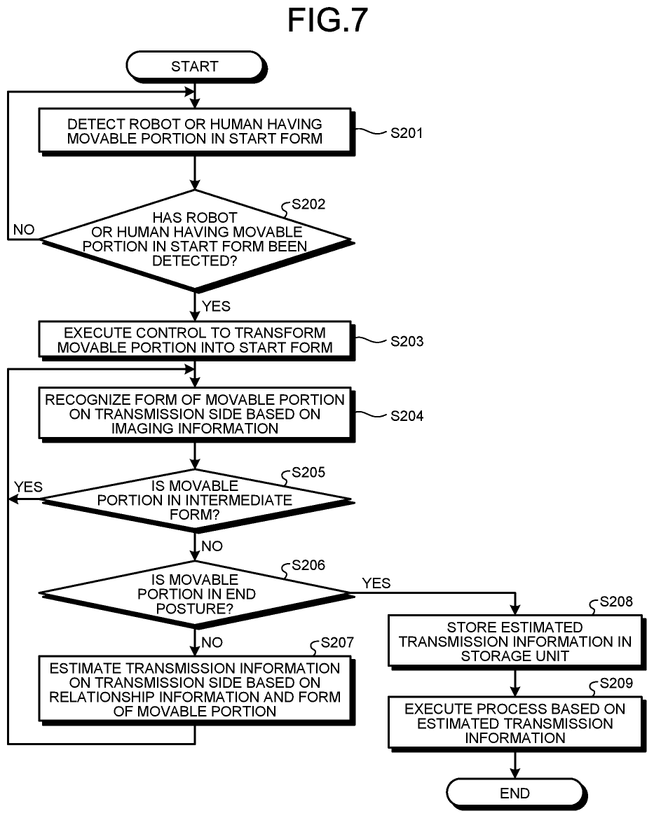

Next, a processing procedure on the receiver side of the robot 100 according to the embodiment will be described with reference to FIG. 7. FIG. 7 is a flowchart illustrating an example of a processing procedure to be executed by the receiver side robot 100B according to the embodiment. The processing procedure illustrated in FIG. 7 is actualized by execution of a program by the control unit 32 of the robot 100B.

As illustrated in FIG. 7, the robot 100B detects the robot 100A or the human having the movable portion 100M in the start form (Step S201). For example, the robot 100B analyzes an image captured by the imaging unit 11, and stores, in the storage unit 31, a result of determining whether the robot 100A or a human having the movable portion 100M in the start form has been detected. After the end of the process of Step S201, the robot 100B proceeds to the process of Step S202.

The robot 100B determines whether the robot 100A or a human having the movable portion 100M in the start form has been detected based on the detection result of Step S201 (Step S202). When having determined that the robot 100A or a human having the movable portion 100M in the start form has not been detected (No in Step S202), the robot 100B returns to the process of Step S201 described above, and continues the processes of Step S201 and subsequent steps. When having determined that the robot 100A or a human having the movable portion 100M in the start form has been detected (Yes in Step S202), the robot 100B proceeds to the process of Step S203.

The robot 100B executes control to transform the movable portion 100M into the start form (Step S203). For example, the robot 100B performs a process of controlling the drive of the drive unit 20 so as to bring the movable portion 100M to the start form. After the movable portion 100M has been transformed into the start form, the robot 100B proceeds to the process of Step S204.

The robot 100B recognizes the form 311M of the movable portion 100M on the transmission side based on imaging information (Step S204). For example, the robot 100B recognizes the form 311M of the movable portion 100M on the transmission side based on the image captured by the imaging unit 11. The robot 100B determines whether the movable portion 100M is in the intermediate form based on the recognition result of Step S204 and the relationship information 311 (Step S205). In a case where the robot 100B has determined that the movable portion 100M is in the intermediate form (Yes in Step S205), the form 311M of the movable portion 100M does not indicate the transmission information 313. Accordingly, the robot 100B returns to the process of Step S204 described above, and continues the processes of Step S204 and subsequent steps. When having determined that the movable portion 100M is not in the intermediate form (No in Step S205), the robot 100B proceeds to the process of Step S206.

The robot 100B determines whether the movable portion 100M is in the end form based on the recognition result of Step S204 and the relationship information 311 (Step S206). When having determined that the movable portion 100M is not in the end form (No in Step S206), the robot 100B proceeds to the process of Step S207 since the shape of the movable portion 100M indicates the transmission information 313.

The robot 100B estimates the transmission information 313 on the transmission side based on the relationship information 311 and the form 311M of the movable portion 100M (Step S207). For example, the robot 100B extracts information associated with the form 311M matching or similar to the form 311M of the movable portion 100M from the relationship information 311, and estimates the extracted information as the transmission information 313. After estimating the transmission information 313, the robot 100B returns to the process of Step S204 described above, and continues the processes of Step S204 and subsequent steps.

When having determined that the movable portion 100M is in the end form (Yes in Step S206), the robot 100B proceeds to the process of Step S208. The robot 100B stores the estimated transmission information 313 in the storage unit 31 (Step S208). The robot 100B executes processes based on the estimated transmission information 313 (Step S209). For example, in a case where the transmission information 313 includes a position element, the robot 100B executes a process for avoiding the position. For example, when the transmission information 313 includes the element of a faulty portion, the robot 100B executes a process for reporting the faulty portion of the robot 100. For example, when the transmission information 313 includes a type element, the robot 100B executes a process for executing a report, a request, a command, or the like indicated by the type. After the end of the process of Step S209, the robot 100B ends the processing procedure illustrated in FIG. 7.

In the example of the processing procedure illustrated in FIG. 7, the robot 100B executes the process of Step S204, whereby the control unit 32 functions as the recognition unit 324. The robot 100B executes the process of Step S207, whereby the control unit 32 functions as the estimation unit 325. The robot 100A executes the process of Step S209, whereby the control unit 32 functions as the operation control unit 323.

[Operation Related to Transmission of Robot According to Embodiment]

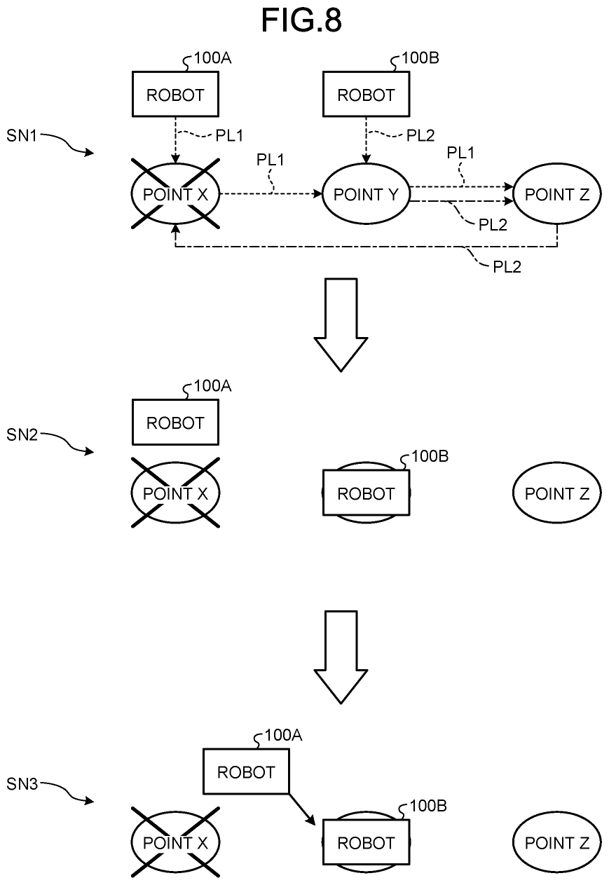

Next, an example of operation related to transmission of the robots 100A and 100B according to the embodiment will be described. FIG. 8 is a diagram illustrating an operation environment of the robot according to the embodiment. Note that it is assumed that the robot 100A and the robot 100B cannot communicate with each other by the communication unit 40.

As illustrated in a scene SN1 of FIG. 8, while autonomously moving points in the order of a point X, a point Y, and a point Z, the robot 100A executes an action plan PL1 for executing a task at each of the points. On the other hand, while autonomously moving points in the order of the point Y, the point Z, and the point X, the robot 100B executes an action plan PL2 for executing a task at each of the points. Note that the action plans PL1 and PL2 are stored in individual plan information 312, for example.

In a scene SN2, the robot 100A recognizes that there is an obstacle on the way to the point X and this hampers movement to the point X. Since movement to the point X is hampered, the robot 100A changes the action plan PL1 so as to move to the point Y. On the other hand, the robot 100B moves to the point Y and executes the task.

In a scene SN3, by the movement to the point Y, the robot 100A approaches the robot 100B executing a task at the point Y. On the other hand, the robot 100B is executing the task at the point Y.

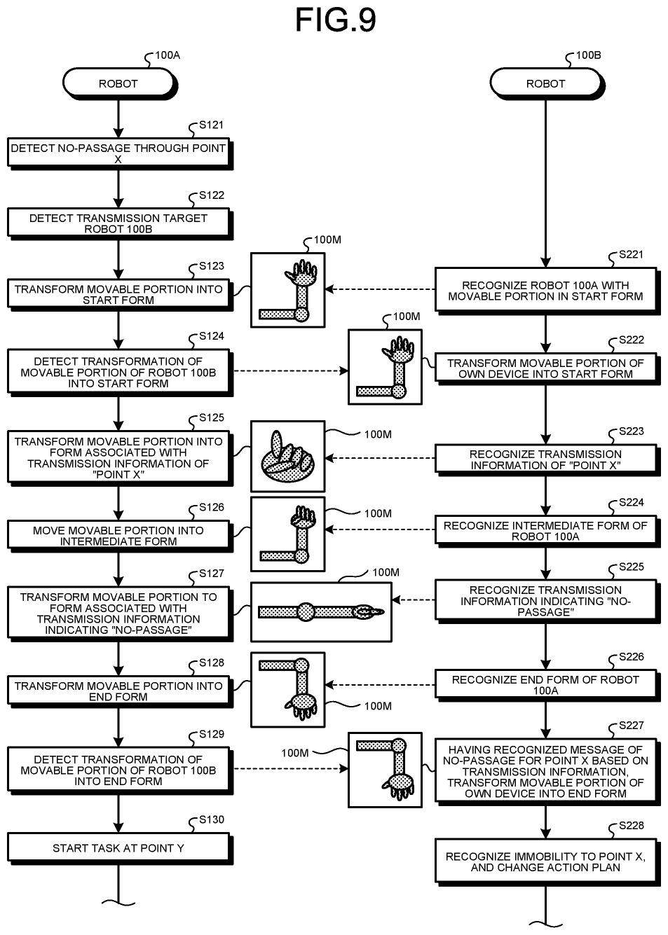

Next, in the scenes SN1 to SN3, an example of operation related to transmission regarding the robots 100A and 100B according to the embodiment will be described. FIG. 9 is a diagram illustrating an operation related to transmission between robots according to the embodiment.

As illustrated in FIG. 9, the robot 100A detects no-passage through the point X (Step S121). The robot 100A detects the robot 100B as the transmission target based on the image captured by the imaging unit 11 (Step S122). The robot 100A transforms the movable portion 100M into a start form (Step S123).

The robot 100B recognizes the robot 100A having the movable portion 100M transformed into the start form based on the image captured by the imaging unit 11 (Step S221). The robot 100B transforms the movable portion 100M of the own device into a start form (Step S222). With this configuration, the robot 100B transmits to the robot 100A that the transmission information 313 can be received.

The robot 100A recognizes that the movable portion 100M of the robot 100B has been transformed into the start form based on the image captured by the imaging unit 11 (Step S124). The robot 100A transforms the movable portion 100M into a form 311M associated to the transmission information 313 of the “point X” (Step S125). On the other hand, the robot 100B recognizes the transmission information 313 of the “point X” based on the image of the movable portion 100M captured by the imaging unit 11 (Step S223).

The robot 100A transforms the movable portion 100M into an intermediate form (Step S126). On the other hand, the robot 100B recognizes the intermediate form of the robot 100A based on the image of the movable portion 100M captured by the imaging unit 11 (Step S224).

The robot 100A transforms the movable portion 100M into the form 311M associated with the transmission information 313 of “no-passage” (Step S127). On the other hand, the robot 100B recognizes the transmission information 313 representing “no-passage” based on an image of the movable portion 100M captured by the imaging unit 11 (Step S225).

The robot 100A transforms the movable portion 100M into an end form (Step S128). On the other hand, the robot 100B recognizes the end form of the robot 100A based on the image of the movable portion 100M captured by the imaging unit 11 (Step S226). Having recognized the message of no-passage for the point X based on the transmission information 313, the robot 100B transforms the movable portion 100M of the own device into the end form (Step S227). Having recognized immobility to the point X, the robot 100B changes the action plan PL2 (Step S228). For example, the robot 100B changes the action plan PL2 so as to move along a route bypassing the point X.

The robot 100A recognizes that the movable portion 100M of the robot 100B has been transformed into the end form based on the image captured by the imaging unit 11 (Step S129). Having successfully transmitted the transmission information 313 to the robot 100B, the robot 100A starts the task at the point Y (Step S130).

Although the present embodiment describes a case where the robot 100B transforms the movable portion 100M into the same form as the form transmitted by the robot 100A, namely, the start form and the end form, the present disclosure is not limited thereto. For example, the robot 100B may use a form in which the movable portion 100M corresponds to an affirmative response, a negative response, or the like.

Furthermore, although the example illustrated in FIG. 9 is a case where the robot 100A performs transmission to the robot 100B, the robot 100B can be replaced with a human. In this case, the human expresses the same form as the start posture of the movable portion 100M of the robot 100A using an arm or a hand, and thereby transmits the preparation completion to the robot 100A. Thereafter, the human is only required to estimate the transmission information 313 by the form 311M of the movable portion 100M of the robot 100A.

As described above, by transforming the movable portion 100M to the form 311M corresponding to the transmission information 313, the robot 100A can transmit the transmission information 313 to the transmission target that has recognized the form 311M. As a result, the robot 100A can achieve information transmission to and from the transmission target by the form 311M of the movable portion 100M, making it possible to transmit information to the transmission target without being affected by communication abnormality. Furthermore, the robot 100A can share information with the robot B even when the robot 100A has no communication unit 40 or has difficulty in communication due to a failure. Furthermore, when a voice recognition function does not normally work with the transmission target, the robot 100A can share information with a human by using the form 311M of the movable portion 100M.

By recognizing the form 311M of the movable portion 100M on the transmission side based on imaging information, the robot 100B can estimate the transmission information 313 associated with the form 311M. As a result, the robot 100B enables transmission of information by the form 311M of the movable portion 100M on the transmission side, making it possible to receive the transmission information 313 without being affected by communication abnormality.

The robot 100 according to the present embodiment can be used, for example, in factories, homes, facilities, and the like as long as it is an environment allowing a plurality of robots 100, or the robot 100 and a human, to exchange information with each other.

### Modification (1) of Embodiment

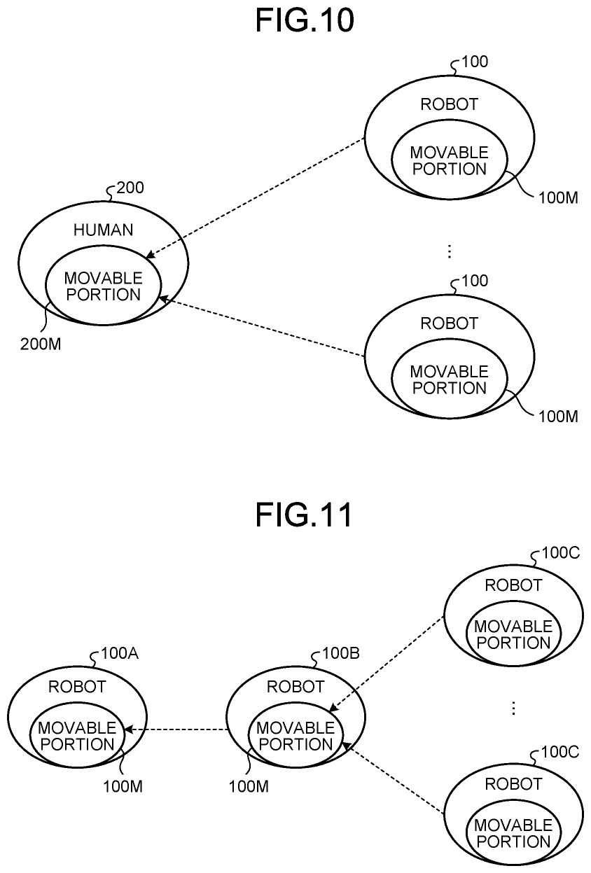

FIG. 10 is a diagram illustrating operation of a robot 100 according to Modification (1) of the embodiment. In the example illustrated in FIG. 10, a human 200 is on a transmission side that transmits transmission information 313 to one or more robots 100. The robot 100 is on a receiver side that receives the transmission information 313 based on a form 311M of a movable portion 200M of the human 200. The movable portion 200M of the human 200 is a portion corresponding to the movable portion 100M of the robot 100, for example. In a case where the movable portion 100M includes an arm 113 and a hand 120, the movable portion 200M includes an arm and a hand of the human 200. The human 200 stores relationship information 311 of the robot 100 and refers to the relationship information 311. The human 200 transforms the movable portion 200M into the form 311M associated with the transmission information 313. On the other hand, the robot 100 estimates the transmission information 313 based on the form 311M of the movable portion 200M of the human 200. With this configuration, even when a communication abnormality occurs, the robot 100 can receive the transmission information 313 from the human 200 based on the form 311M of the movable portion 200M of the human 200. As a result, even in a state where the communication unit 40 is not usable, the robot 100 can share the transmission information 313 with another robot 100 and the human 200. Note that the human 200 may transmit the transmission information 313 to another human 200 by modifying the form 311M of the movable portion 200M.

### Modification (2) of Embodiment

FIG. 11 is a diagram illustrating operation of a robot 100 according to Modification (2) of the embodiment. In the example illustrated in FIG. 11, a robot 100A transmits transmission information 313 to a robot 100B, and transmits the transmission information 313 received by the robot 100B to a plurality of robots 100C. The robot 100B is on a receiver side that receives the transmission information 313 with respect to the robot 100A. Having received the transmission information 313, the robot 100B operates as a transmission side that transmits the transmission information 313 to the robot 100C. With this configuration, the robot 100 can share the transmission information 313 with the plurality of other robots 100 even when the communication abnormality occurs.

### Modification (3) of Embodiment

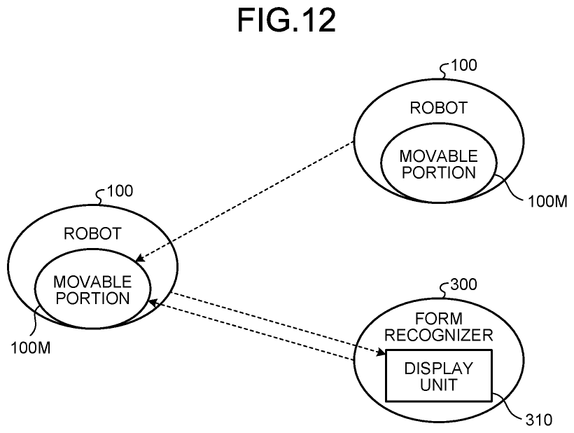

FIG. 12 is a diagram illustrating operation of a robot 100 according to Modification (3) of the embodiment. In the example illustrated in FIG. 12, the robot 100 transmits the transmission information 313 to another robot 100 and a form recognizer 300 by transforming the form 311M of the movable portion 100M. The form recognizer 300 is an electronic device that does not include the movable portion 100M of the robot 100 and has a function of recognizing the form 311M of the movable portion 100M.

For example, the form recognizer 300 has functions corresponding to the recognition unit 324 and the estimation unit 325 of the information processing device 30 described above. The form recognizer 300 recognizes the form of the movable portion 100M of the robot 100, and estimates the transmission information 313 based on the form and the relationship information 311. The form recognizer 300 executes a process based on the estimated transmission information 313. Furthermore, the form recognizer 300 may include a display unit 310 that displays the estimated transmission information 313, the transmission information 313 to be transmitted, and the like to the outside. The display unit 310 includes, for example, a display device that displays various types of information. Examples of the display device include a liquid crystal display (LCD) device, an organic light emitting diode (OLED) device, and a touch panel. The form recognizer 300 may transmit the transmission information 313 to the robot 100 using, for example, a character, a QR code (registered trademark), or the like. With this configuration, by transmitting the transmission information 313 to the form recognizer 300, the robot 100 can transmit the transmission information 313 even in a case where a communication abnormality occurs and there is no other robot 100 or human around. As a result, by quickly transmitting the transmission information 313, the robot 100 can contribute to the spread of the transmission information 313. By using the display unit, the form recognizer 300 can transmit the transmission information 313 earlier than transmission only by the robot 100 or a human.

Furthermore, the detection unit 321 of the robot 100 may detect information displayed on the display unit 310 of the form recognizer 300 as the transmission information 313. For example, the detection unit 321 recognizes information such as texts, numbers, characters, and the like displayed on the display unit 310 of the form recognizer 300, and sets the recognized information as the transmission information 313. Based on the relationship information 311, the robot 100 specifies, by using the specifying unit 322, the form 311M of the movable portion 100M used in the transmission of the transmission information 313 to the transmission target. In the robot 100, the operation control unit 323 executes control to transform the movable portion 100M into the specified form 311M. With this configuration, the robot 100 can transmit the information from the form recognizer 300 to the other robot 100 by the form 311M of the movable portion 100M, making it possible to enhance the convenience.

Modifications (1) to (3) of the embodiment may be applied to the robot 100 of the embodiment and the modifications or used in combination.

### Application Example of Embodiment

In the present embodiment, the case where the robot 100 transmits the transmission information 313 to another robot 100, a human, or the like by the form 311M of the movable portion 100M has been described. In addition, for example, humans may transmit the transmission information 313 by the form 311M of the movable portion 200M to each other. With this configuration, even in a case where the human cannot understand a sign language, it is possible to perform simple information transmission between the humans as long as the human understands the form 311M of the movable portion 100M.

[Hardware Configuration]

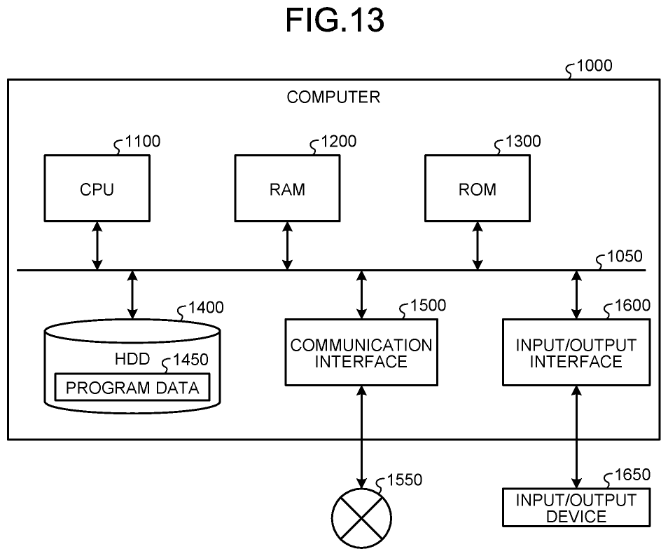

The information processing device 30 of the robot 100 according to the above-described embodiment may be actualized by a computer 1000 having a configuration as illustrated in FIG. 13, for example. Hereinafter, the information processing device 30 according to the embodiment will be described as an example. FIG. 13 is a hardware configuration diagram illustrating an example of the computer 1000 that actualizes functions of an information processing device 30. The computer 1000 includes a CPU 1100, RAM 1200, read only memory (ROM) 1300, a hard disk drive (HDD) 1400, a communication interface 1500, and an input/output interface 1600. Individual components of the computer 1000 are interconnected by a bus 1050.

The CPU 1100 operates based on a program stored in the ROM 1300 or the HDD 1400 so as to control each of components. For example, the CPU 1100 develops a program stored in the ROM 1300 or the HDD 1400 into the RAM 1200 and executes processes corresponding to various programs.

The ROM 1300 stores a boot program such as a basic input output system (BIOS) executed by the CPU 1100 when the computer 1000 starts up, a program dependent on hardware of the computer 1000, or the like.

The HDD 1400 is a non-transitory computer-readable recording medium that records a program executed by the CPU 1100, data used by the program, or the like. Specifically, the HDD 1400 is a recording medium that records an information processing program according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting between an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface for reading a program or the like recorded on a predetermined recording medium. Examples of the media include optical recording media such as a digital versatile disc (DVD), a magneto-optical recording medium such as a magneto-optical disk (MO), a tape medium, a magnetic recording medium, and semiconductor memory.

For example, in a case where the computer 1000 functions as the information processing device 30 according to the embodiment, the CPU 1100 of the computer 1000 executes a program loaded on the RAM 1200 to implement the functions in the control unit 32, such as functions of the detection unit 321, the specifying unit 322, the operation control unit 323, the recognition unit 324, the estimation unit 325, and the like. In addition, the HDD 1400 stores a program according to the present disclosure and data in the storage unit 31. While the CPU 1100 executes the program data 1450 read from the HDD 1400, the CPU 1100 may acquire these programs from another device via the external network 1550, as another example.

The preferred embodiments of the present disclosure have been described in detail above with reference to the accompanying drawings. However, the technical scope of the present disclosure is not limited to such examples. It will be apparent to those skilled in the art of the present disclosure that various modifications and alterations can be conceived within the scope of the technical idea described in the claims and naturally fall within the technical scope of the present disclosure.

Furthermore, the effects described in the present specification are merely illustrative or exemplary and are not limited. That is, the technique according to the present disclosure can exhibit other effects that are apparent to those skilled in the art from the description of the present specification in addition to or instead of the above effects.

It is also possible to create a program for the hardware such as CPU, ROM, and RAM built in a computer to exert the functions equivalent to the configuration of the information processing device 30, and a computer-readable recording medium that has recorded the program can also be provided.

Furthermore, individual steps related to the processes of the robot 100 in the present specification do not necessarily have to be processed in chronological order in the order described in the flowchart. For example, individual steps related to the processes of the robot 100 may be processed in an order different from the order described in the flowchart, or may be processed in parallel.

(Effects)

The robot 100 includes the movable portion 100M transformable into a plurality of different forms, the storage unit 31 that stores relationship information 311 indicating a relationship between the form and the transmission information 313, the specifying unit 322 that specifies a form used for transmitting the transmission information 313 to the transmission target based on the relationship information 311, and the operation control unit 323 that performs control to transform the movable portion 100M into the form specified by the specifying unit 322.

With this configuration, by transforming the movable portion 100M into the form corresponding to the transmission information 313, the robot 100 can transmit the transmission information 313 to the transmission target that has recognized the form. As a result, the robot 100 can achieve information transmission to and from the transmission target by the form of the movable portion 100M, making it possible to transmit information to the transmission target without being affected by communication abnormality.

In the robot 100, when transmitting the plurality of pieces of transmission information 313, the specifying unit 322 specifies the form for each of the plurality of pieces of transmission information 313, and the operation control unit 323 performs control to transform the movable portion 100M into the plurality of forms specified by the specifying unit 322.

With this configuration, by transforming the form of the movable portion 100M every time the plurality of pieces of transmission information 313 is transmitted, the robot 100 can combine and transmit the plurality of pieces of transmission information 313 to the transmission target. As a result, the robot 100 can transmit various transmission information 313 to the transmission target, making it possible to share more information with surrounding robots and humans without being affected by communication abnormality.

The robot 100 further includes the detection unit 321 that detects an event of transmitting the transmission information 313 to the transmission target, and the operation control unit 323 performs control to transform the movable portion 100M to the form specified by the specifying unit 322 when the detection unit 321 has detected the event.

With this configuration, the robot 100 can transmit the transmission information 313 to the transmission target by the transformation of the form of the movable portion 100M in response to the detection of the event of transmission of the transmission information 313. As a result, the robot 100 can promptly transmit information to the transmission target only by setting the event of transmission without being affected by the communication abnormality.

In the robot 100, the relationship information 311 further includes a start form indicating the start of transmission of the transmission information 313, and the operation control unit 323 performs control to transform the movable portion 100M into a form associated with the transmission information 313 after transforming the movable portion 100M into the start form.

With this configuration, in a case where the start form is included in the relationship information 311, by transforming the movable portion 100M into the start form, the robot 100 can allow the transmission target to recognize the difference between the form of the movable portion 100M attributed to the task operation and the form of the movable portion 100M attributed to the transmission of the transmission information 313. As a result, even when the form of the movable portion 100M is used for transmission, the robot 100 can suppress the possibility that the transmission target erroneously recognizes the form of the movable portion 100M.

In the robot 100, the relationship information 311 further includes an intermediate form of joining the plurality of pieces of transmission information 313, and when the movable portion 100M is transformed into the form, the operation control unit 323 performs control to transform the movable portion 100M into the next form after transforming the movable portion 100M into the intermediate form.

With this configuration, in a case where the intermediate form is included in the relationship information 311, when the movable portion 100M is transformed into the form, the robot 100 can transform the movable portion 100M into the next form after transforming the movable portion 100M into the intermediate form. As a result, by resetting the transmission information between the form of the movable portion 100M and the next form, the robot 100 can suppress erroneous recognition even when a plurality of pieces of transmission information is transmitted to the transmission target.

In the robot 100, the relationship information 311 further includes an end form indicating the end of the transmission of the transmission information 313, and the operation control unit 323 performs control to transform the movable portion 100M into the end form in a case where the transmission of the transmission information 313 has ended.

With this configuration, in a case where the end form is included in the relationship information 311, by transforming the movable portion 100M into the end form, the robot 100 can transmit the end of transmission of the transmission information 313 to the transmission target side. As a result, the robot 100 can allow the transmission target to correctly recognize the transmission end of the transmission information 313 even when the form of the movable portion 100M is used for transmission.

In the robot 100, when having detected that the transmission information 313 is recognized by the transmission target, the operation control unit 323 determines an end of the transmission of the transmission information 313.

With this configuration, the robot 100 does not determine the end of the transmission of the transmission information 313 until the transmission target has recognized the transmission information 313. As a result, since the robot 100 does not end the transmission until the transmission target has recognized the transmission information 313, it is possible to suppress the possibility that the transmission target erroneously recognizes the form of the movable portion 100M.

In the robot 100, the transmission information 313 includes at least one piece of information out of a transmission source, a transmission target, a position, a faulty portion, an importance level, a report, and a request, regarding the transmission information 313.

With this configuration, by transforming the movable portion 100M into the form corresponding to the transmission information, the robot 100 can transmit a plurality of types of transmission information associated with the form to the transmission target. As a result, the robot 100 can achieve information transmission to and from the transmission target by the form of the movable portion 100M, making it possible to transmit more information to the transmission target without being affected by communication abnormality.

The robot 100 further includes the communication unit 40, and when the communication state of the communication unit 40 is abnormal, the operation control unit 323 performs control to transform the movable portion 100M into a form associated with the transmission information 313.

With this configuration, when the communication state of the communication unit 40 becomes abnormal, the robot 100 can transmit the transmission information 313 to the transmission target by the form of the movable portion 100M. As a result, the robot 100 can transmit information by the form of the movable portion 100M when the communication state of the communication unit 40 is abnormal, and can transmit and receive information via the communication unit 40 when the communication state of the communication unit 40 is normal, leading to enhanced convenience.

The transmission target for the robot 100 is at least one of the other robot 100 or the human 200.

With this configuration, the robot 100 can transmit the transmission information 313 to another robot 100, the human 200, and the like by transforming the movable portion 100M to a form corresponding to the transmission information. As a result, the robot 100 can transmit information by the form of the movable portion 100M, making it possible to transmit information to another robot 100, the human 200, and the like without being affected by communication abnormality.

The robot 100 includes the storage unit 31 that stores the relationship information 311 indicating the relationship between the transmission information and the form of the movable portion 100M on the transmission side that transmits the transmission information 313; the imaging unit 11 that images the movable portion 100M on the transmission side; the recognition unit 324 that recognizes the form of the movable portion 100M on the transmission side based on the imaging information obtained by imaging by the imaging unit 11; and the estimation unit 325 that estimates the transmission information 313 on the transmission side based on the relationship information 311 and the form recognized by the recognition unit 324.

With this configuration, by recognizing the form of the movable portion 100M on the transmission side based on the imaging information, the robot 100 can estimate the transmission information 313 associated with the form. As a result, the robot 100 enables transmission of information by the form of the movable portion 100M on the transmission side, making it possible to receive the transmission information 313 without being affected by communication abnormality.

In the robot 100, the relationship information 311 further includes a start form indicating the start of transmission of the transmission information, the recognition unit 324 recognizes the start form of the movable portion 100M on the transmission side, and the estimation unit 325 starts estimation of the transmission information 313 based on the form after the recognition unit 324 has recognized the start form.

With this configuration, in a case where the start form is included in the relationship information 311, by transformation of the movable portion 100M on the transmission side into the start form, the robot 100 can distinguish the difference between the form of the movable portion 100M attributed to the task operation and the form of the movable portion 100M attributed to the transmission of the transmission information 313. As a result, even when the form of the movable portion 100M on the transmission side is used for transmission, the robot 100 can suppress the possibility of erroneous recognition of the form of the movable portion 100M.

In the robot 100, the relationship information 311 further includes an intermediate form that joins the plurality of pieces of transmission information 313, the recognition unit 324 recognizes the intermediate form of the movable portion 100M on the transmission side, and the estimation unit 325 associates the transmission information 313 estimated before and after the intermediate form after the recognition unit 324 has recognized the intermediate form.

With this configuration, in a case where the intermediate form is included in the relationship information 311, the robot 100 can associate the transmission information 313 estimated before and after the intermediate form after recognizing the intermediate form of the movable portion 100M on the transmission side. As a result, even when the transmission information 313 is reset between the form of the movable portion 100M on the transmission side and the next form, the robot 100 can estimate the plurality of pieces of transmission information 313 as continuous information, making it possible to increase the amount of information to be transmitted.

In the robot 100, the relationship information 311 further includes an end form indicating the end of transmission, the recognition unit 324 recognizes the end form of the movable portion 100M on the transmission side, and the estimation unit 325 ends the estimation of the transmission information 313 after the recognition unit 324 has recognized the end form.

With this configuration, in a case where the end form is included in the relationship information 311, by recognizing the end form of the movable portion 100M on the transmission side, the robot 100 can recognize the end of the transmission of the transmission information 313. As a result, the robot 100 can correctly recognize the end of transmission of the transmission information 313 even when the form of the movable portion 100M on the transmission side is used for transmission.

The robot 100 further includes the movable portion 100M that is transformable into a plurality of different forms, and the operation control unit 323 that performs control to transform the movable portion 100M into the form indicating that the estimation unit 325 has estimated the transmission information 313.

With this configuration, by transforming the movable portion 100M to the form indicating that the transmission information 313 has been estimated, the robot 100 can transmit to the transmission side whether the transmission information 313 has been estimated. As a result, the robot 100 can allow the transmission side to grasp the transmission status of the transmission information 313 and the like, making it possible to avoid transformation of the movable portion 100M on the transmission side before the end of the estimation of the transmission information 313.

The robot 100 further includes the communication unit 40, and the recognition unit 324 recognizes the form of the movable portion 100M on the transmission side when the communication state of the communication unit 40 has abnormality.

With this configuration, when the communication state of the communication unit 40 has abnormality, the robot 100 can estimate the transmission information 313 by the form of the movable portion 100M on the transmission side. As a result, the robot 100 can receive information by the form of the movable portion 100M on the transmission side when the communication state of the communication unit 40 has abnormality, and can transmit and receive information via the communication unit 40 when the communication state of the communication unit 40 is normal, leading to enhanced convenience.

A transmission method is a transmission method to be executed by a robot including the movable portion 100M transformable into a plurality of different forms. The transmission method includes: storing relationship information 311 indicating a relationship between a form and transmission information in the storage unit 31; specifying the form of transmitting the transmission information 313 to the transmission target based on the relationship information 311; and transforming the movable portion 100M into the specified form.

With this configuration, according to the transmission method, by transforming the movable portion 100M into the form corresponding to the transmission information by the robot 100, it is possible to transmit the transmission information 313 to the transmission target that has recognized the form. As a result, the transmission method enables information transmission between the robot 100 and the transmission target by the form of the movable portion 100M, making it possible to transmit information to the transmission target without being affected by communication abnormality.

A transmission estimation method is a transmission estimation method to be executed by a computer including the storage unit 31 that stores the relationship information 311 indicating a relationship between the transmission information 313 and the form of the movable portion 100M on the transmission side that transmits transmission information 313. The method includes: imaging the movable portion 100M on the transmission side by the imaging unit 11, recognizing the form of the movable portion 100M on the transmission side based on the imaging information obtained by imaging; and estimating the transmission information 313 on the transmission side based on the relationship information 311 and the recognized form.

With this configuration, according to the transmission estimation method, by recognizing, by the computer, the form of the movable portion 100M on the transmission side based on the imaging information, it is possible to estimate the transmission information 313 associated with the form. As a result, the transmission estimation method enables transmission of information by the form of the movable portion 100M on the transmission side, making it possible to receive, by the computer, the transmission information 313 without being affected by communication abnormality.

Note that the following configurations also belong to the technical scope of the present disclosure.

(1)

A robot comprising:

a movable portion transformable into a plurality of different forms;

a storage unit that stores relationship information indicating a relationship between the form and transmission information;

a specifying unit that specifies the form used for transmitting the transmission information to a transmission target based on the relationship information; and

a first control unit that performs control to transform the movable portion into the form specified by the specifying unit.

(2)

The robot according to (1), wherein,

in a case of transmitting a plurality of pieces of transmission information, the specifying unit specifies the form for each of the plurality of pieces of the transmission information, and

the first control unit performs control to transform the movable portion into the plurality of forms specified by the specifying unit.

(3)

The robot according to (1) or (2), further comprising

a detection unit that detects an event of transmitting the transmission information to the transmission target, wherein,

in a case where the detection unit has detected the even, the first control unit performs control to transform the movable portion into the form specified by the specifying unit.

(4)

The robot according to any one of (1) to (3), wherein

the relationship information further includes a start form indicating a start of transmission of the transmission information, and

the first control unit performs control to transform the movable portion into the form associated with the transmission information after transforming the movable portion to the start form.

(5)

The robot according to (4), wherein

the relationship information further includes an intermediate form of joining a plurality of pieces of the transmission information, and

when having transformed the movable portion into the form, the first control unit performs control to transform the movable portion into the form in next order after transforming the movable portion to the intermediate form.

(6)

The robot according to (4) or (5), wherein

the relationship information further includes an end form indicating an end of transmission of the transmission information, and

in a case where the transmission of the transmission information has ended, the first control unit performs control to transform the movable portion into the end form.

(7)

The robot according to (6), wherein,

when having detected that the transmission information has been recognized by the transmission target, the first control unit determines an end of the transmission of the transmission information.

(8)

The robot according to any one of (1) to (7), wherein

the transmission information includes at least one piece of information out of a transmission source, the transmission target, a position, a faulty portion, an importance level, a report, and a request, regarding the transmission information.

(9)

The robot according to any one of (1) to (8), further comprising a communication unit, wherein,

in a case where a communication state of the communication unit has abnormality, the first control unit performs control to transform the movable portion into the form associated with the transmission information.

(10)

The robot according to any one of (1) to (9), wherein

the transmission target is at least one of another robot or a human.

(11)

A robot comprising:

a storage unit that stores relationship information indicating a relationship between transmission information and a form of a movable portion on a transmission side that transmits the transmission information;

an imaging unit that images the movable portion on the transmission side;

a recognition unit that recognizes the form of the movable portion on the transmission side based on imaging information obtained by imaging by the imaging unit; and

an estimation unit that estimates the transmission information on the transmission side based on the relationship information and the form recognized by the recognition unit.

(12)

The robot according to (11), wherein

the relationship information further includes a start form indicating a start of transmission of the transmission information,

the recognition unit recognizes the start form of the movable portion on the transmission side, and

the estimation unit starts estimation of the transmission information based on the form after the recognition unit has recognized the start form.

(13)

The robot according to (12), wherein

the relationship information further includes an intermediate form of joining a plurality of pieces of the transmission information,

the recognition unit recognizes the intermediate form of the movable portion on the transmission side, and

the estimation unit associates the transmission information estimated before and after the intermediate form after the recognition unit has recognized the intermediate form.

(14)

The robot according to (12) or (13), wherein

the relationship information further includes an end form indicating an end of the transmission,

the recognition unit recognizes the end form of the movable portion on the transmission side, and

the estimation unit ends the estimation of the transmission information after the recognition unit has recognized the end form.

(15)

The robot according to (13), further comprising:

a movable portion transformable into a plurality of different forms;

a second control unit that performs control to transform the movable portion into the form indicating that the estimation unit has estimated the transmission information.

(16)

The robot according to (15), further comprising

a communication unit, wherein

the recognition unit recognizes the form of the movable portion on the transmission side when the communication state of the communication unit has abnormality.

(17)

A transmission method to be executed by a robot including a movable portion transformable into a plurality of different forms, the transmission method comprising:

storing relationship information indicating a relationship between the form and transmission information into a storage unit;

specifying the form of transmitting the transmission information to a transmission target based on the relationship information; and transforming the movable portion into the specified form.

(18)

A transmission estimation method to be executed by a computer including a storage unit that stores relationship information indicating a relationship between transmission information and a form of a movable portion on a transmission side that transmits the transmission information, the transmission estimation method comprising:

imaging the movable portion on the transmission side by an imaging unit; recognizing the form of the movable portion on the transmission side based on imaging information obtained by imaging; and

estimating the transmission information on the transmission side based on the relationship information and the form that has been recognized.

### REFERENCE SIGNS LIST

10 SENSOR UNIT
11 IMAGING UNIT
20 DRIVE UNIT
30 INFORMATION PROCESSING DEVICE
31 STORAGE UNIT
32 CONTROL UNIT
40 COMMUNICATION UNIT
100 ROBOT
100M MOVABLE PORTION
113 ARM
120 HAND
311 RELATIONSHIP INFORMATION
311M FORM
313 TRANSMISSION INFORMATION
321 DETECTION UNIT
322 SPECIFYING UNIT
323 OPERATION CONTROL UNIT
324 RECOGNITION UNIT
325 ESTIMATION UNIT
P1, P2 TRANSMISSION RULE

1. A robot comprising:
a movable portion transformable into a plurality of different forms;
a storage unit that stores relationship information indicating a relationship between the form and transmission information;
a specifying unit that specifies the form used for transmitting the transmission information to a transmission target based on the relationship information; and
a first control unit that performs control to transform the movable portion into the form specified by the specifying unit.

2. The robot according to claim 1, wherein,
in a case of transmitting a plurality of pieces of transmission information, the specifying unit specifies the form for each of the plurality of pieces of the transmission information, and
the first control unit performs control to transform the movable portion into the plurality of forms specified by the specifying unit.

3. The robot according to claim 2, further comprising
a detection unit that detects an event of transmitting the transmission information to the transmission target, wherein,
in a case where the detection unit has detected the even, the first control unit performs control to transform the movable portion into the form specified by the specifying unit.

4. The robot according to claim 3, wherein
the relationship information further includes a start form indicating a start of transmission of the transmission information, and
the first control unit performs control to transform the movable portion into the form associated with the transmission information after transforming the movable portion to the start form.

5. The robot according to claim 4, wherein
the relationship information further includes an intermediate form of joining a plurality of pieces of the transmission information, and
when having transformed the movable portion into the form, the first control unit performs control to transform the movable portion into the form in next order after transforming the movable portion to the intermediate form.

6. The robot according to claim 4, wherein
the relationship information further includes an end form indicating an end of transmission of the transmission information, and
in a case where the transmission of the transmission information has ended, the first control unit performs control to transform the movable portion into the end form.

7. The robot according to claim 6, wherein,
when having detected that the transmission information has been recognized by the transmission target, the first control unit determines an end of the transmission of the transmission information.

8. The robot according to claim 2, wherein
the transmission information includes at least one piece of information out of a transmission source, the transmission target, a position, a faulty portion, an importance level, a report, and a request, regarding the transmission information.

9. The robot according to claim 1, further comprising a communication unit, wherein,
in a case where a communication state of the communication unit has abnormality, the first control unit performs control to transform the movable portion into the form associated with the transmission information.

10. The robot according to claim 1, wherein
the transmission target is at least one of another robot or a human.

11. A robot comprising:
a storage unit that stores relationship information indicating a relationship between transmission information and a form of a movable portion on a transmission side that transmits the transmission information;
an imaging unit that images the movable portion on the transmission side;
a recognition unit that recognizes the form of the movable portion on the transmission side based on imaging information obtained by imaging by the imaging unit; and
an estimation unit that estimates the transmission information on the transmission side based on the relationship information and the form recognized by the recognition unit.

12. The robot according to claim 11, wherein
the relationship information further includes a start form indicating a start of transmission of the transmission information,
the recognition unit recognizes the start form of the movable portion on the transmission side, and
the estimation unit starts estimation of the transmission information based on the form after the recognition unit has recognized the start form.

13. The robot according to claim 12, wherein
the relationship information further includes an intermediate form of joining a plurality of pieces of the transmission information,
the recognition unit recognizes the intermediate form of the movable portion on the transmission side, and
the estimation unit associates the transmission information estimated before and after the intermediate form after the recognition unit has recognized the intermediate form.

14. The robot according to claim 13, wherein
the relationship information further includes an end form indicating an end of the transmission,
the recognition unit recognizes the end form of the movable portion on the transmission side, and
the estimation unit ends the estimation of the transmission information after the recognition unit has recognized the end form.

15. The robot according to claim 13, further comprising:
a movable portion transformable into a plurality of different forms;
a second control unit that performs control to transform the movable portion into the form indicating that the estimation unit has estimated the transmission information.

16. The robot according to claim 15, further comprising
a communication unit, wherein
the recognition unit recognizes the form of the movable portion on the transmission side when the communication state of the communication unit has abnormality.

17. A transmission method to be executed by a robot including a movable portion transformable into a plurality of different forms, the transmission method comprising:
storing relationship information indicating a relationship between the form and transmission information into a storage unit;
specifying the form of transmitting the transmission information to a transmission target based on the relationship information; and transforming the movable portion into the specified form.

18. A transmission estimation method to be executed by a computer including a storage unit that stores relationship information indicating a relationship between transmission information and a form of a movable portion on a transmission side that transmits the transmission information, the transmission estimation method comprising:
imaging the movable portion on the transmission side by an imaging unit; recognizing the form of the movable portion on the transmission side based on imaging information obtained by imaging; and
estimating the transmission information on the transmission side based on the relationship information and the form that has been recognized.
